(19) United States
(12) Patent Application Publication
(10) Pub. No.: US 2007/0261377 A1
(43) Pub. Date: Nov. 15, 2007

(54) SPIN-ON FILTER ARRANGEMENT AND METHODS

(76) Inventor: Jerry John Klug, Rosemount, MN (US)

Correspondence Address: MERCHANT & GOULD PC, P.O. BOX 2903, MINNEAPOLIS, MN, 55402-0903, US

(21) Appl. No.: 11/382,565

(22) Filed: May 10, 2006

(51) Int. Cl. B01D 46/00

(52) U.S. Cl. 55/498

(57) ABSTRACT

A spin-on filter cartridge includes a housing, a filter media, first end cap, and a thread ring. The thread ring extends between an open mouth of the housing and the first end cap. The thread ring is a single-piece structure having a first region, a second region, and a third region. The first region is secured to the housing. The second region is axially and radially spaced from the first region. The second region is threaded for selective attachment to a suitably threaded filter head. The third region is axially spaced from the first and second regions. The third region defines a fluid aperture arrangement therethrough. The second and third regions are radially spaced from the housing wall. A filter assembly includes a filter head having a spud and a threaded wall. A spin-on filter cartridge is operably mounted and dismounted on the filter head. Methods of installing and servicing includes fluids filters of the type described.

### TECHNICAL FIELDS

This disclosure concerns generally a fluid filter. In particular, this disclosure relates to a disposable filter for spinning on (or threadably connecting) to a filter head for uses for engine lubrication fluids, fuel, or hydraulic fluids.

### BACKGROUND

Filters have been employed in a variety of applications including hydraulic systems and engine lubrication systems. Such filter assemblies generally include a cylindrical filter element within a can or housing with a baffle or attachment plate at one end to connect the filter to a filter head, typically by a threaded joint. A central opening and several surrounding openings in the baffle direct flow through the filter and, in particular, the filter element. The flow can be in either an inside-out or an outside-in pattern.

Various models and designs of filters have been known over the years. Continued improvements in filters are desired.

### SUMMARY OF THE DISCLOSURE

A spin-on filter cartridge is provided including a housing, filter media, a first end cap, and a thread ring. The thread ring extends between an open mouth of the housing and the first end cap. The thread ring is a single-piece structure having a first region, a second region, and a third region. The first region is secured to the housing. The second region is axially and radially spaced from the first region. The second region is threaded for selective attachment to a suitably threaded filter head. The third region is axially spaced from the first and second regions. The third region defines a fluid aperture arrangement therethrough. The second and third regions are radially spaced from the housing wall.

A filter assembly is provided including a filter head having a spud and a threaded wall. A spin-on filter cartridge is constructed and arranged to be operably mounted and dismounted on the filter head. The filter cartridge can be one as summarized herein.

In other aspects, methods of installing and servicing includes fluids filters of the type described.

### BRIEF DESCRIPTION OF THE DRAWINGS

FIG. 1 is a cross-sectional view of a filter assembly including a filter cartridge secured to a filter head, constructed according to principles of this disclosure; the cross-section taken along the line 1-1 of FIG. 2;

FIG. 2 is a top plan view of the filter assembly of FIG. 1;

FIG. 3 is a cross-sectional view of the filter cartridge of FIG. 1 removed from the filter head;

FIG. 4 is a perspective view of a system incorporating the filter assembly of FIGS. 1-3; and

FIG. 5 is a cross-sectional view of an alternative embodiment of the filter cartridge of FIG. 1.

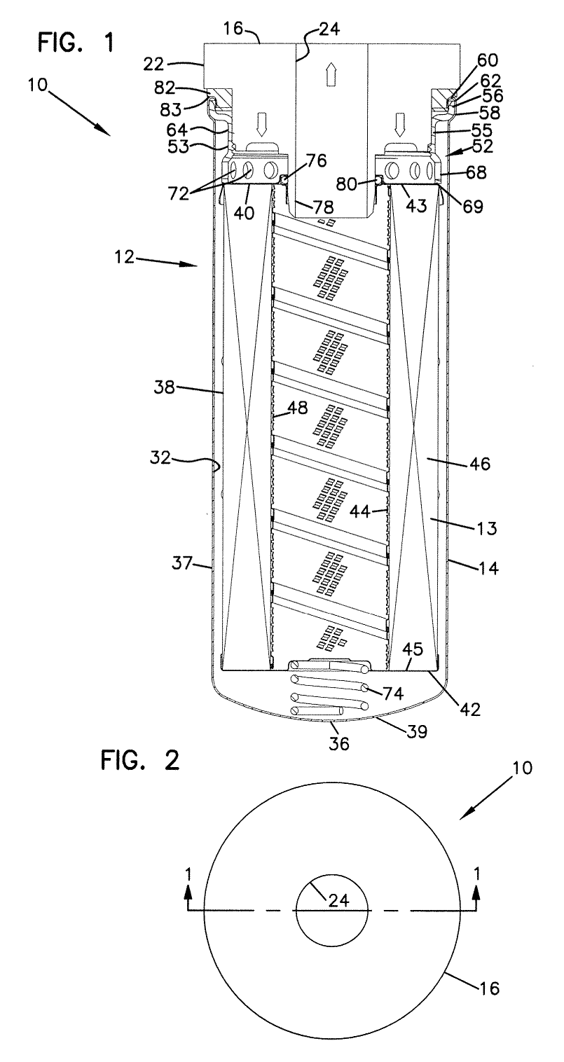

### DETAILED DESCRIPTION

### A. Overall Assembly; Systems of Use

Referring first to FIG. 1, there is illustrated a fluid filter assembly 10. Filter assembly 10 is particularly adapted for filtration of liquid, for example oil, as for example in a lube system for an over the highway truck. The filter assembly 10 includes a filter cartridge or element 12 operably oriented on a filter block or filter head 16, typically by threadably connecting (i.e., screwing or “spinning on”). In the one depicted, the filter cartridge 12 includes filter media 13 operably oriented in a can or housing 14.

The filter assembly 10 is utilized in a filtering system. The filtering system includes a supply for supplying dirty fluid to the filter assembly 10 through an inlet 22 of the filter head 16. The fluid enters and is filtered or cleaned by the filter element 12. The cleaned fluid exits the filter head 16 at an outlet 24.

In reference now to FIG. 4, one application for the filter assembly 10 is to remove particulate matter from oil that is used on an engine 28 for vehicles such as an over the highway truck. Other applications for the filter assembly 10 include farm equipment, construction equipment, skidders, loaders, off-road vehicles, automobiles, industrial machines, and other devices that require the filtering of fluids. Additionally, the filter assembly 10 can be used to remove foreign matter from a variety of different fluids. Examples of liquid fluids include hydraulic fluids, engine lubrication oil, diesel fuel, gasoline, engine coolant, automatic transmission fluid and others.

### B. Improved Filter Assembly 10

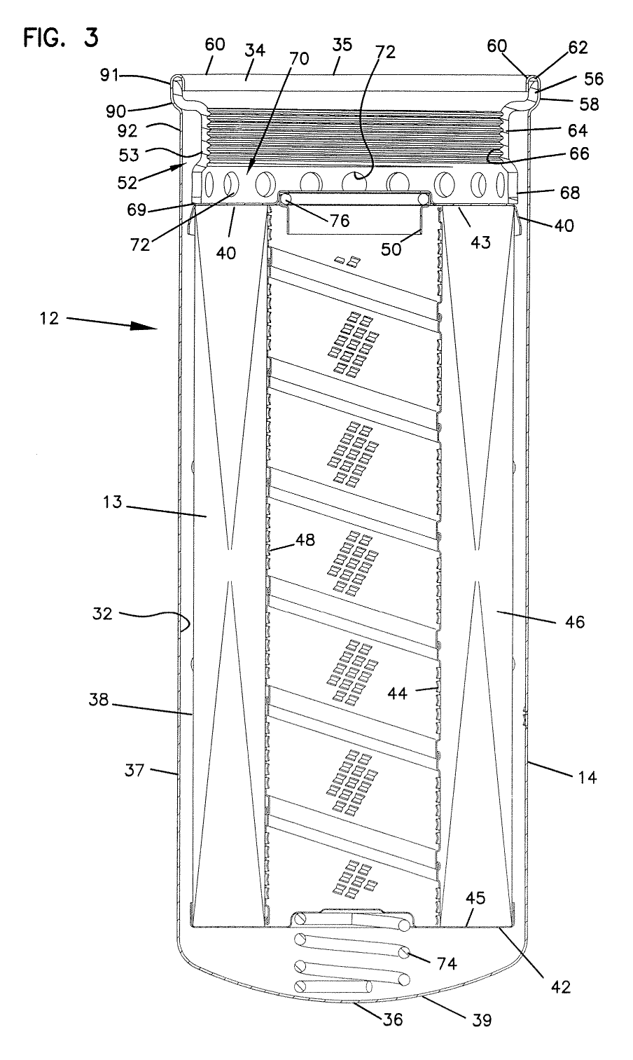

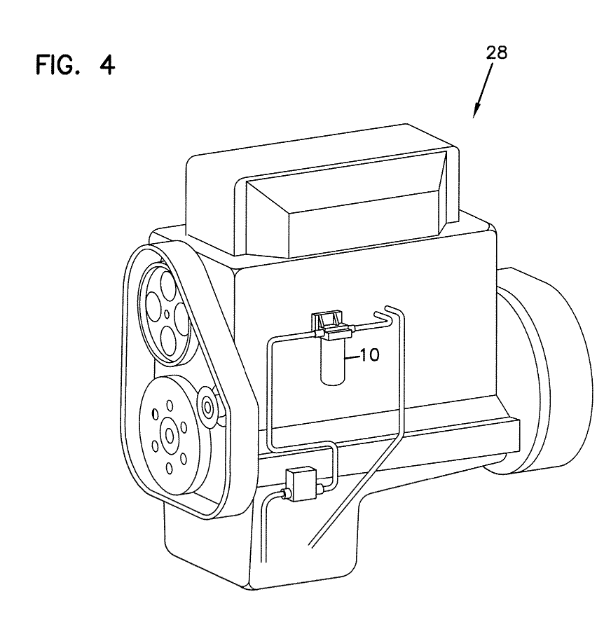

In reference now to FIGS. 1 and 3, the filter cartridge 12 includes housing 14. The filter housing 14 has an interior volume 32 designed to hold the filter media 13 therein. The filter housing 14 generally has a mouth 34 (FIG. 3) at an open first end 35 (FIG. 3), a surrounding wall 37, and a closed bottom 39 at a second end 36. Preferably, the housing 14 is of generally thin-walled construction having sufficient rigidity to withstand the pressure experienced during typical filtering operations. Housing 14 is typically metal, or other suitable materials, such as a strong non-metal; if housing 14 is metal, it is typically formed by stamping or drawing.

The filter media 13, in the embodiment shown, is generally a tubular extension 38, depicted as cylindrical, of media 13 operably mounted in the interior volume 32 of the housing 14. The media 13, when in the form of tubular extension 38, defines an open filter interior 44. The tubular extension 38, in the embodiment shown, has first and second opposite ends 43, 45. The first end 43, in the particular embodiment depicted, is secured to a first end cap 40. The first end cap 40 defines an opening 50 (FIG. 3), which is in communication with the open filter interior 44. In the embodiment depicted, there is also a second end cap 42 secured to the second end 45 of the tubular extension 38. The second end cap 42 is depicted in FIGS. 1 and 3 as being closed. Typically, the filter media 13 is material such as cellulous, paper, non-woven material, synthetic material, and the like. The filter material 13 may be treated or coated to improve its filtering capabilities.

In the one shown, the filter media 13 is pleated media 46, generally paper. A perforated tubular inner liner 48 can be included to help support the media 13. The inner liner 48 is surrounded, or circumscribed by, the tubular extension 38. The inner liner 48 typically extends between the first and second end caps 40, 42.

A thread ring 52 extends between the open mouth 34 of the housing 14 and the first end cap 40. In the embodiment shown, the thread ring 52 is a single piece construction 53.

In general, the thread ring 52 functions to both secure the filter cartridge 12 to the filter head 16 and permit the flow of fluid from the filter head 16 to the filter media 13, when the filter assembly 10 is functioning in an outside to inward flow application. In the embodiment shown, the thread ring 52, as a single piece construction 53, has at least three regions. A first region 56 is secured to the housing 14. In the embodiment shown, the housing 14 has an expanded diameter region 58 that terminates with a U-shaped bend 60, formed as a portion bent over an end tip 62 of the first region 56. The first region 56 defines a first diameter.

The first region 56 of the thread ring 52 cooperates with the housing 14 to result in easier manufacturing with less variability and greater control then over prior art constructions. For example, the filter housing 14 defines a step or shoulder 90 between expanded diameter region 58 and diameter portion 92 of the housing 14. Specifically, the expanded diameter region 58 is the portion of the housing 14 that is immediately adjacent to the mouth 34. It has a diameter that is greater than the housing portion 92. The step or shoulder 90 is a transition point between the region 58 and housing portion 92. When the filter cartridge 12 is assembled, the shoulder 90 is used for helping with assembly. To assemble, first, the thread ring 52 is placed on a surface, such as a conveyor. Next, the filter media 13 with the first and second end caps 43, 45 is oriented on the thread ring 52. Next, a spring 74 is oriented on the second end cap 45. Next, the housing 14 is inserted over the assembly including the thread ring 52, filter media 13, and spring 74. The thread ring 52 is pressed into the housing 14 until it stops on the shoulder 90. Next, the assembly is inverted, and is followed by a seaming operation, in which the bend 60 is formed to be bent over the end tip 62 of the first region 56.

The single piece construction 53 of the thread ring 52 further includes a second region 64 both axially and radially spaced from the first region 56. In preferred embodiments, the second region 64 is threaded along its inner surface 66 (FIG. 3) to selectively mateably connect with mating threads on the filter head 16. In the example depicted, the filter head 16 has a threaded wall 55 that mates with the inner threaded surface 66 of the second region 64. The second region 64 defines a second diameter. In the embodiment shown, the second diameter is less than the first diameter of the first region 56. In preferred arrangements, the second diameter is at least 70% of the first diameter, and in many preferred arrangements, is at least 75% of the first diameter.

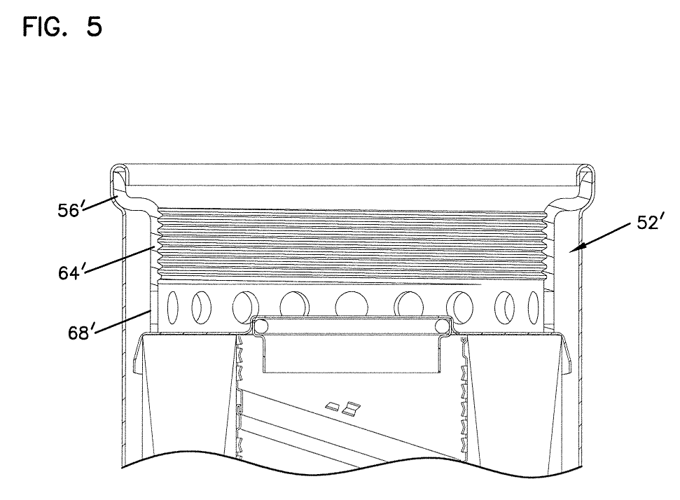

The thread ring 52 further includes a third region 68 axially spaced from the first and second regions 56, 64. In the embodiment shown, the third region 68 also defines a fluid aperture arrangement 70 (FIG. 3) extending through the thread ring 52. The fluid aperture arrangement 70 can include slots, cutouts, or any variety of holes in order to permit the flow of fluid entering the cartridge 12 from the filter head 16 through the thread ring 52. In the embodiment shown, the fluid aperture arrangement 70 comprises a plurality of spaced holes 72 extending through the third region 68. The third region 68 defines a third diameter, which in the embodiment shown in FIGS. 1 and 3, is between the first diameter and the second diameter. The second diameter is smaller than the third diameter and is typically at least 70% for example, at least 75% of the third diameter. FIG. 5 shows an alternate embodiment for thread ring 52′, in which the third diameter is equal to the second diameter. The thread ring 52′ includes first region 56′, second region 64′, and third region 68′. The third region 68′ has third diameter equal to second diameter of the second region 64′.

In the embodiment shown, the third region 68 is radially spaced from the housing wall 37. This radial spacing allows a volume for the liquid to pass when it flows from the filter head 16 through the holes 72 and into the interior volume 32, before flowing through the filter media 13 and out of the filter assembly 10 through the outlet 24. In the embodiment shown, the second region 64 is also radially spaced from the housing wall 37.

A spring 74 extends between the second end 36 of the housing 14 and the second end cap 42. While a coiled spring 74 is shown, of course, other biasing mechanisms could be used.

The filter assembly 10 further includes a seal member 76 located between the first end cap 40 and the spud 78 of the filter head 16. When the filter cartridge 12 is spun onto the filter head 16, a seal member 76 will compress against the spud 78 and form a seal 80 between the filter cartridge 12 and the filter head 16.

A seal member 82 is located between the filter head 16 and the U-shaped bend 60 of the housing 14 to form another seal 83 between the filter head 16 and the housing 14. FIGS. 3 and 5 depict the filter cartridge 12 without the seal member 82, for purposes of clarity in showing the remaining structure. It should be understood that preferred arrangements of the filter cartridge 12 include the seal member 82 as a part of the filter cartridge 12.

In FIGS. 1 and 3, note how an end 69 of the third region 68 of the thread ring 52 is axially engaged against the first end cap 40. This arrangement prevents flow from passing anywhere other than through the fluid aperture arrangement 10.

### C. Methods

In operation, the filter assembly 10 works as follows: in an outside to inside operation, fluid to be cleaned enters the filter head through inlet 22. From there, it flows through the openings 72 in the thread ring 52 and into the open interior volume 32 of the filter housing 14. From there, the fluid is forced to flow through the filter media 13 and into the open interior volume 44. The fluid is prevented from bypassing the filter media 13 due to seal 80 formed between the end cap 40 and the spud 78 of the filter head 16. The seal 83 between the housing 14 and the filter head 16 prevents leakage to the outside.

From the open interior volume 44, the cleaned fluid passes through the outlet 24 of the filter head 16.

After a period of operation, the filter media 13 will become occluded. The occluded filter media 13 will cause an increase in restriction. At such time, it will become appropriate to change and replace the filter assembly. In order to do this, the filter cartridge 12 will be released from the filter head 16 by unscrewing the filter cartridge 12 from the filter head 16. This will release seals 80 and 83. The old filter cartridge 12 is discarded and replaced with a new filter cartridge 12. The new filter cartridge 12 is screwed onto the filter head 16 and filtering can then be restarted.

A method of assembling a filter cartridge is provided. The method includes providing housing 14. The housing 14 is generally cylindrical and includes closed bottom 36 and open mouth 34. The housing 14 also defines shoulder 90 adjacent to the mouth 34. The U-shaped bend will not be formed in the housing 14 at this stage. To assemble, first, the thread ring 52 is placed on a surface, such as a conveyor. Next, the filter media 13 with the first and second end caps 43, 45 is oriented on the thread ring 52. Next, a spring 74 is oriented on the second end cap 45. Next, the housing 14 is inserted over the assembly including the thread ring 52, filter media 13, and spring 74. The thread ring 52 is pressed into the housing 14 until it stops on the shoulder 90. Next, the assembly is inverted, and is followed by a seaming operation, in which the bend 60 is formed to be bent over the end tip 62 of the first region 56.

What is claimed is:

1. A spin-on filter cartridge comprising:
(a) a housing having an interior volume, a surrounding wall, a closed bottom, and an open mouth;
(b) a tubular extension of filter media operably mounted in the interior volume of the housing; the tubular extension of filter media having first and second opposite ends and an open filter interior;
(c) a first end cap secured to the first end of the filter media; the first end cap defining an opening in communication with the open filter interior;
(d) a thread ring extending between the open mouth of the housing and the first end cap; the thread ring including a single piece structure having:
(i) a first region secured to the housing;
(ii) a second region axially and radially spaced from the first region; the second region being threaded;
(iii) a third region axially spaced from the first and second regions; the third region defining a fluid aperture arrangement therethrough; and
(A) wherein the second and third regions are radially spaced from the housing wall.

2. A spin-on filter cartridge according to claim 1 wherein:
(a) the third region is radially outwardly spaced from the second region.

3. A spin-on filter cartridge according to claim 1 wherein:
(a) the first region defines a first diameter and the second region defines a second diameter; the second diameter is less than and at least 70% of the first diameter.

4. A spin-on filter cartridge according to claim 3 wherein:
(a) the third region defines a third diameter; the third diameter being between the first diameter and the second diameter.

5. A spin-on filter cartridge according to claim 3 wherein:
(a) the third region defines a third diameter; the third diameter being equal to the second diameter.

6. A spin-on filter cartridge according to claim 1 wherein:
(a) the fluid aperture arrangement comprises a plurality of spaced holes extending through the third region.

7. A spin-on filter cartridge according to claim 1 further including:
(a) a second end cap secured to the second end of the filter media; the second end cap being a closed end cap.

8. A spin-on filter cartridge according to claim 7 further including:
(a) a spring oriented in the interior volume of the housing between the housing closed end and the second end cap.

9. A spin-on filter cartridge according to claim 1 further including:
(a) an inner liner circumscribed by the tubular extension of media.

10. A spin-on filter cartridge according to claim 1 wherein:
(a) the filter housing includes a portion bent over an end tip of the first region.

11. A spin-on filter cartridge according to claim 1 wherein:
(a) the tubular extension of filter media is pleated media.

12. A spin-on filter cartridge according to claim 3 wherein:
(a) the filter housing defines a shoulder in engagement with the first region.

13. A filter assembly comprising:
(a) a filter head having a spud and a threaded wall; and
(b) a spin-on filter cartridge constructed and arranged to be operably mounted and dismounted on the filter head; the filter cartridge including:
(i) a housing having an interior volume, a surrounding wall, a closed bottom, and an open mouth;
(ii) a tubular extension of filter media operably mounted in the interior volume of the housing; the tubular extension of filter media having first and second opposite ends and an open filter interior;
(iii) a first end cap secured to the first end of the filter media; the first end cap defining an opening in communication with the open filter interior;
(A) the spud of the filter head extending through the opening in the first end cap;
(iv) a thread ring extending between the open mouth of the housing and the first end cap; the thread ring including a single piece structure having:
(A) a first region secured to the housing;
(B) a second region axially and radially spaced from the first region; the second region being threaded for threadably mating with the threaded wall of the filter head;
(C) a third region axially spaced from the first and second regions; the third region defining a fluid aperture arrangement therethrough; and
(1) wherein the second and third regions are radially spaced from the housing wall.

14. A filter assembly according to claim 13 further including:
(a) a seal member between the first end cap and the spud of the filter head.

15. A filter assembly according to claim 13 wherein:
(a) the filter housing includes a portion bent over an end tip of the first region.

16. A filter assembly according to claim 15 further including:
(a) a seal member between the filter head and the bent over portion of the housing.

17. A filter assembly according to claim 13 wherein:
(a) the first region defines a first diameter and the second region defines a second diameter; the second diameter is less than and at least 70% of the first diameter;
(b) the third region defines a third diameter; the third diameter being between the first diameter and the second diameter;
(c) the fluid aperture arrangement comprises a plurality of spaced holes extending through the third region;
(d) a second end cap is secured to the second end of the filter media; the second end cap being a closed end cap; and
(e) a spring is oriented in the interior volume of the housing between the housing closed end and the second end cap.

18. A filter assembly according to claim 13 wherein:
(a) the first region defines a first diameter and the second region defines a second diameter; the second diameter is less than and at least 70% of the first diameter;
(b) the third region defines a third diameter; the third diameter being equal to the second diameter;
(c) the fluid aperture arrangement comprises a plurality of spaced holes extending through the third region;
(d) a second end cap is secured to the second end of the filter media; the second end cap being a closed end cap; and
(e) a spring is oriented in the interior volume of the housing between the housing closed end and the second end cap.

19. A method of installing a filter cartridge; the method comprising:
(a) spinning a filter cartridge onto a filter head; the filter head having a spud and a threaded wall; the filter cartridge including:
(i) a housing having an interior volume, a surrounding wall, a closed bottom, and an open mouth;
(ii) a tubular extension of filter media operably mounted in the interior volume of the housing; the tubular extension of filter media having first and second opposite ends and an open filter interior;
(iii) a first end cap secured to the first end of the filter media; the first end cap defining an opening in communication with the open filter interior;
(A) the spud of the filter head extending through the opening in the first end cap;
(iv) a thread ring extending between the open mouth of the housing and the first end cap; the thread ring including a single piece structure having:
(A) a first region secured to the housing;
(B) a second region axially and radially spaced from the first region; the second region being threaded for threadably mating with the threaded wall of the filter head;
(C) a third region axially spaced from the first and second regions; the third region defining a fluid aperture arrangement therethrough; and
(1) wherein the second and third regions are radially spaced from the housing wall.

20. A method according to claim 19 wherein:
(a) the step of spinning includes forming a seal between the spud of the filter head and the first end cap.

21. A method of constructing a filter cartridge; the method comprising:
(a) providing a thread ring including a single piece structure having:
(I) a first region;
(ii) a second region axially and radially spaced from the first region; the second region being threaded; and
(iii) a third region axially spaced from the first and second regions; the third region defining a fluid aperture arrangement therethrough;
(b) orienting a tubular extension of filter media with a first end cap secured to the filter media against the thread ring;
(c) providing a filter housing having a surrounding wall defining an interior, a closed bottom, an open mouth providing access to the interior, and a shoulder adjacent to the mouth; and orienting the mouth of the filter housing over the tubular extension of filter media and thread ring;
(d) engaging the first region of the thread ring against the housing shoulder; and
(e) securing the thread ring to the housing by bending the housing wall over an end tip of the first region of the thread ring.
